(19) United States
(12) Patent Application Publication
(10) Pub. No.: US 2025/0227184 A1
(43) Pub. Date: Jul. 10, 2025

(54) OPERATION INFORMATION GENERATING APPARATUS AND OPERATION INFORMATION GENERATING METHOD

(71) Applicant: Konica Minolta, Inc., Tokyo (JP)

(72) Inventors: Hirokazu HIGASHIUCHI, Tokyo (JP); Hiroki TOMITA, Sagamihara-shi (JP)

(21) Appl. No.: 19/014,858

(22) Filed: Jan. 9, 2025

(30) Foreign Application Priority Data
Jan. 10, 2024 (JP) 2024-002061

(51) Int. Cl. H04N 1/00; H04N 1/32

(52) U.S. Cl. CPC H04N 1/00832; H04N 1/32101; H04N 2201/3202

(57) ABSTRACT

An operation information generating apparatus includes a hardware processor. The hardware processor is configured to obtain operation state history information on an operation state of an image forming apparatus and maintenance history information on maintenance performed on an image former of the image forming apparatus, generate operation information in which the operation state history information and the maintenance history information are arranged on a timeline, and output the generated operation information to a terminal apparatus.

### CROSS-REFERENCE TO RELATED APPLICATIONS

The entire disclosure of Japanese Patent Application No. 2024-002061 filed on Jan. 10, 2024 is incorporated herein by reference in its entirety.

### TECHNICAL FIELD

The present invention relates to an operation information generating apparatus and an operation information generating method.

### DESCRIPTION OF RELATED ART

An image forming apparatus employing the ink jet system ejects ink from a head. A spray of ink, remaining ink droplets, and an ink mist generated when ejected may adhere to nozzle surfaces. Since the adhered ink mist and ink droplets cover the nozzle surfaces and cause ejection failure, periodical cleaning of the nozzle surfaces is desired. However, excessive cleaning may accelerate deterioration of the nozzle surfaces. When the nozzle surfaces are deteriorated, the head is replaced. Purchasing a head costs much and causes an unnecessary expense.

An inkjet image forming apparatus may use ultraviolet (UV) ink. When UV ink is used, curing of the ink adhered to the nozzle surfaces progresses as time goes by, owing to light leaking from the UV curing lamp, light entering from outside the image forming apparatus, and so forth. Since the cured ink is difficult to remove as compared to water-based ink, it is desirable to perform cleaning of an image forming apparatus using UV ink at appropriate timing.

In a known operation, an operator of the image forming apparatus learns cleaning timing and cleaning procedure. The operator performs maintenance including cleaning of the nozzle surfaces, based on what he/she learned. However, according to such an operation, a human error may occur, such as omission of execution of maintenance.

Japanese Unexamined Patent Publication No. 2018-092224 discloses a printer controller that prompts a user to perform maintenance when an appropriate maintenance timing arrives, for example.

JP2018-092224A describes that appropriate maintenance timing is determined, based on a predetermined maintenance interval. However, appropriate maintenance timing also depends on the operation state of the image forming apparatus, such as the number of printed sheets and stand-by time.

The present invention has been made in consideration of the above. An object of the present invention is to allow a user to determine appropriate maintenance timing of an image forming apparatus.

### SUMMARY OF THE INVENTION

To achieve the above object, according to an aspect of the present invention, there is provided an operation information generating apparatus including a hardware processor configured to obtain operation state history information on an operation state of an image forming apparatus and maintenance history information on maintenance performed on an image former of the image forming apparatus, generate operation information in which the operation state history information and the maintenance history information are arranged on a timeline, and output the generated operation information to a terminal apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic diagram illustrating an overall configuration of an operation information visualizing system according to an embodiment of the present invention;

FIG. 2 is a block diagram illustrating an example of a functional configuration of an operation information generating apparatus according to an embodiment of the present invention;

FIG. 3 is a block diagram illustrating an example of a hardware configuration of each apparatus constituting the operation information visualizing system according to an embodiment of the present invention;

FIG. 4 is a diagram illustrating an example of operation information displayed on a screen of a display part of a terminal apparatus according to an example 1 of an embodiment of the present invention;

FIG. 5 is an example of a flowchart of the process of an operation information generating process by an operation information generating apparatus according to the Example 1 of an embodiment of the present invention;

FIG. 6 is a diagram illustrating an example of operation information displayed on the screen of the display part of the terminal apparatus according to the example 2 of an embodiment of the present invention;

FIG. 7 is an example of a flowchart of the operation information generating process by the operation information generating apparatus according to an Example 2 of an embodiment of the present invention;

FIG. 8 is a diagram illustrating an example of operation information displayed on the screen of the display part of the terminal apparatus according to an Example 3 of an embodiment of the present invention;

FIG. 9 is an example of a flowchart of the operation information generating process by the operation information generating apparatus according to the Example 3 of an embodiment of the present invention;

FIG. 10 is a diagram illustrating an example of operation information displayed on the screen of the display part of the terminal apparatus according to an Example 4 of an embodiment of the present invention;

FIG. 11 is an example of a flowchart of the operation information generating process by the operation information generating apparatus according to the Example 4 of an embodiment of the present invention;

FIG. 12 is a diagram illustrating an example of operation information displayed on the screen of the display part of the terminal apparatus according to an Example 5 of an embodiment of the present invention; and

FIG. 13 is an example of a flowchart of the operation information generating process by the operation information generating apparatus according to the Example 5 of an embodiment of the present invention.

### DETAILED DESCRIPTION

Hereinafter, embodiments of the present invention will be described with reference to the accompanying drawings. In this specification and the drawings, constituent elements having substantially the same functions or configurations are denoted by the same reference numerals, and redundant description of the constituent elements is omitted.

### Configuration of Operation Information Visualizing System

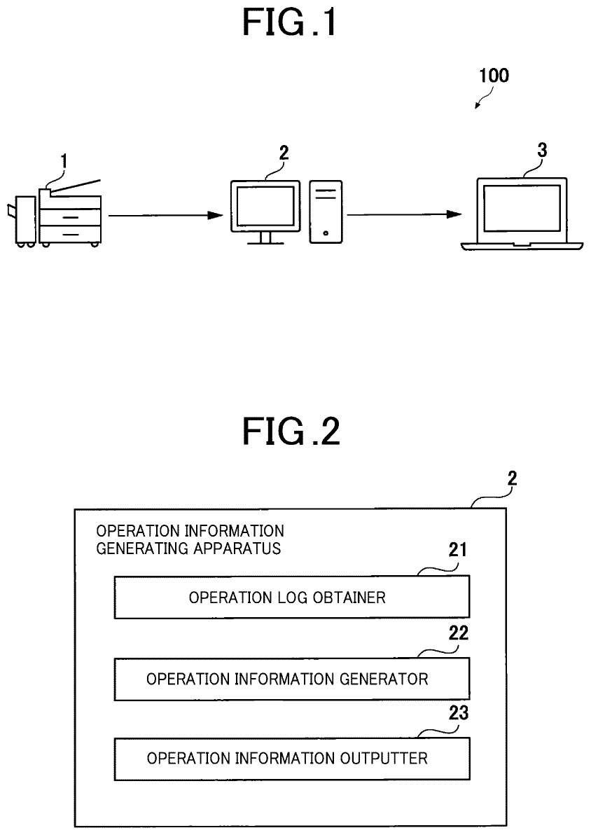

First, an overall configuration of an operation information visualizing system according to an embodiment of the present invention is described with reference to FIG. 1. FIG. 1 is a schematic diagram illustrating an overall configuration of the operation information visualizing system 100. FIG. 1 illustrates elements necessary for the description of the present invention or related elements. The operation information visualizing system of the present invention is not limited to the example illustrated in FIG. 1.

As illustrated in FIG. 1, the operation information visualizing system 100 includes an image forming apparatus 1, an operation information generating apparatus 2, and a terminal apparatus 3. These apparatuses constituting the operation information visualizing system 100 are communicably connected to each other via a network (not illustrated).

The image forming apparatus 1 is configured to form an image on a sheet by the inkjet method. The image forming apparatus 1 forms (prints) an image on a recording medium such as a paper sheet or a cloth. based on a print job input by a printer controller (not illustrated). A storage section (not illustrated) of the image forming apparatus 1 stores information indicating an operation state of the image forming apparatus 1 and maintenance history information as an operation log.

The operation information generating apparatus 2 is installed in, for example, a cloud environment, and obtains an operation log from the image forming apparatus 1. The operation information generating apparatus 2 generates operation information to be displayed on a dashboard (not illustrated) and uploads the operation information to the dashboard. The operation information generating apparatus 2 generates operation information. The operation information includes both (i) operation state information of the image forming apparatus 1 and (ii) maintenance history information on maintenance performed on nozzles (an example of an image former, not illustrated) of the image forming apparatus 1.

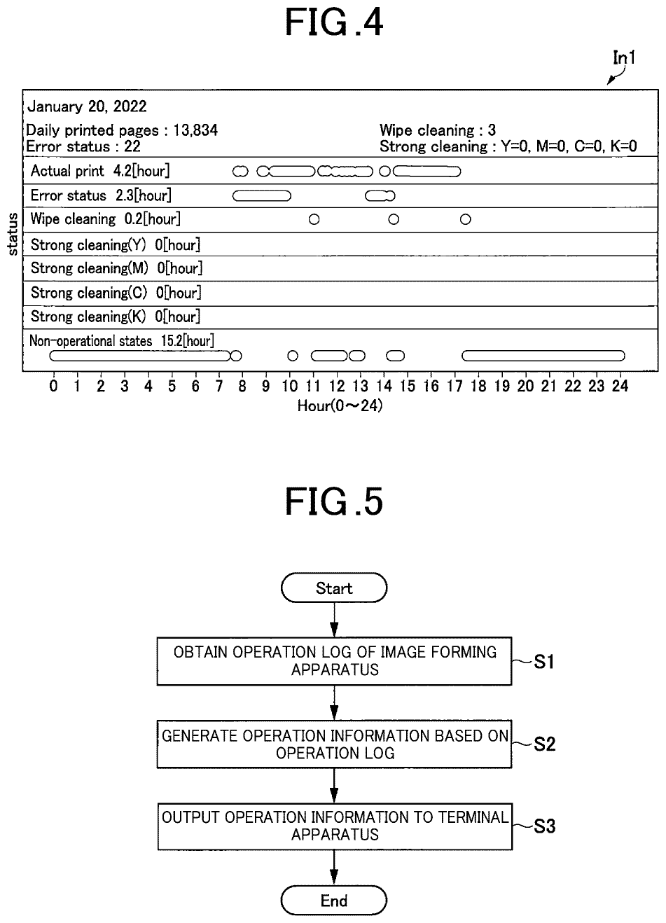

The terminal apparatus 3 is disposed, for example, in a company in which the image forming apparatus 1 is disposed. The terminal apparatus 3 accesses the operation information generating apparatus 2 in accordance with an operation by a user. The terminal apparatus 3 then causes the display part 53 (see FIG. 4) to display an operation information display screen provided by the dashboard.

### Functional Configuration of Operation Information Visualizing Apparatus

Next, the functional configuration of the operation information generating apparatus 2 will be described. FIG. 2 is a block diagram illustrating an example of a functional configuration of the operation information generating apparatus 2. As illustrated in FIG. 2, the operation information generating apparatus 2 includes an operation log obtainer 21, an operation information generator 22, and an operation information outputter 23.

The operation log obtainer 21 (hardware processor, an example of a history information obtainer) obtains an operation log from the image forming apparatus 1 and stores the operation log in a bucket (not illustrated) or the like on the cloud. The function of the operation log obtainer 21 can be implemented by using a technology, such as web distributed authoring and versioning (WebDAV), for example.

The operation information generator 22 (hardware processor) generates operation information by using the operation logs in the buckets and stores the operation information in the buckets. The operation information includes both operation state information of the image forming apparatus 1 and maintenance history information performed on nozzles or the like of the image forming apparatus 1.

The operation information outputter 23 (hardware processor) reads the operation information stored in the bucket and outputs the read information to the dashboard.

### Control System Configuration of Operation Information Visualizing System

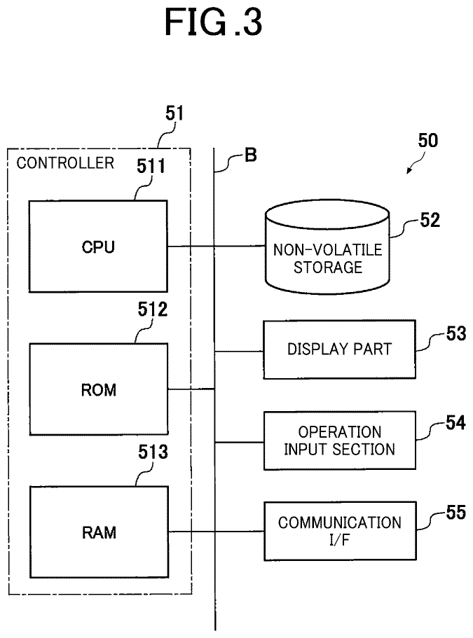

Next, a control system configuration of the image forming apparatus 1, the operation information generating apparatus 2, and the terminal apparatus 3 constituting the operation information visualizing system 100 will be described. FIG. 3 is a block diagram illustrating an example of the hardware configuration of each apparatus constituting the operation information visualizing system 100. The computer 50 illustrated in FIG. 3 is hardware used as a computer.

The computer 50 includes a controller 51, a non-volatile storage 52, a display part 53, an operation input section 54, and a communication interface (I/F) 55. These components are connected to a bus B.

The controller 51 includes a CPU (Central Processing Unit) 511 (a hardware processor), a ROM (Read Only Memory) 512, and a RAM (Random Access Memory) 513.

The CPU 511 reads, from the ROM 512, program codes of software for implementing functions of the present embodiment, loads the program codes in the RAM 513, and executes the program codes. Variables and parameters generated during arithmetic processing by the CPU 511 are temporarily written in the RAM 513.

The controller 51 may include a processing apparatus such as a micro-processing unit (MPU) instead of the CPU 511. Furthermore, the controller 51 may use a CPU in combination with an MPU. Furthermore, the controller 51 may be constituted of a field-programmable gate array (FPGA), an application specific integrated circuit (ASIC), or the like.

As the nonvolatile storage 52, for example, a hard disk drive (HDD), a solid state drive (SSD), an optical disk, a nonvolatile memory card, or the like is used. The non-volatile storage 52 stores operation logs of the image forming apparatus 1. The non-volatile storage 52 also serves as the bucket that stores the operation logs obtained by the operation information generating apparatus 2 and the operation information generated by the operation information generating apparatus 2.

The non-volatile storage 52 stores a software program for implementing each function according to the present embodiment, as well as an operating system (OS) and various parameters. The program may be stored in ROM

The program is stored in the form of a computer-readable program code. The CPU511 sequentially executes operations in accordance with the program code. That is, the non-volatile storage 52 and/or the ROM 512 are used as an example of a computer-readable non-transitory storage medium that stores a program to be executed by a computer.

The display part 53 is, for example, a monitor constituted of a liquid crystal display (LCD). The display part 53 of the terminal apparatus 3 displays operation information and so forth.

The operation input section 54 includes a keyboard and a mouse, for example. The operation input section 54 generates manipulation signals corresponding to manipulations by the user and supplies the manipulation signals to the CPU 511.

The display part 53 and the operation input section 54 may be integrally configured as a touch screen.

The communication I/F 55 is a network interface card (NIC), for example. The communication I/F 55 can send and receive various kinds of information to and from an external apparatus over a network or via a communication line.

### Example 1

Next, an example 1 of an embodiment of the present invention will be described. In the example 1, the operation information generating apparatus 2 generates operation information In1. The operation information In1 includes both operation state information and maintenance history information of the image forming apparatus 1 that are arranged on the same timeline.

### Display Example of Operation Information

FIG. 4 is a diagram illustrating an example of the operation information In1 displayed on the screen of the display part 53 (see FIG. 2) of the terminal 3.

In FIG. 4, the operation information In1 is illustrated in the form of a timeline. Along the vertical axis of the operation information In1, items of operation state information and items of cleaning history information of the image forming apparatus 1 are arranged. The horizontal axis indicates time (0 to 24 o'clock) in the timeline.

On the upper left of the operation information In1, the date is shown. Under the date, items of “daily printed pages” and “error status” are shown. The item “daily printed pages” indicates the number of printed sheets per day by the image forming apparatus 1. In the example illustrated in FIG. 4, “daily printed pages” are 13,834 (sheets).

The item of “Error status” indicates the number of times of error occurrences in the image forming apparatus 1. The error includes, for example, a jam occurrence. In the item “Error status” in FIG. 4, the number of times of error occurrences per day is 22 (times) as an example. The number of printed sheets per day and the number of times of jam occurrences are thus displayed. The user can determine to perform maintenance when the number of printed sheets and/or the number of times of jam occurrences are greater than usual, for example.

The items “Wipe cleaning” and “Strong cleaning” are displayed in the upper right corner of the operation information In1. The item “Wipe cleaning” indicates the number of times of execution of wipe cleaning per day. Wipe cleaning refers to wiping the nozzle surface with a cloth. Wipe cleaning is generally performed for all colors of Y (Yellow), M (Magenta), C (Cyan), and K (Black) at the same time. In the example illustrated in FIG. 4, the number of times of wipe cleaning is 3 (times).

The item “Strong cleaning” indicates the number of times of execution of strong cleaning per day. Strong cleaning is performed when imaging failure or the like occurs. Strong cleaning is performed on nozzles detected as having ejection failure. Strong cleaning includes ejection of ink from the nozzles and wipe cleaning of the nozzle surfaces.

Along the vertical axis of the operation information In1 illustrated in FIG. 4, items “Actual print” and “Error status” are displayed as the operation state information. The item “Actual print” indicates a printing time (hour) of the image forming apparatus 1, namely a time during which printing was performed. FIG. 4 indicates that the printing time of the image forming apparatus 1 is 4.2 hours. On the timeline, the length of printing time by the image forming apparatus 1 is indicated by a circle mark or a mark of connected circles. Further, on the timeline, the positions of the marks indicate the time (hours) at which printing is performed. In the other statuses such as “Wipe cleaning” and so forth, the time and the duration of each status are also indicated by circle marks or connected circle marks.

The item “Error status” indicates a time (hour) during which an error occurred in the image forming apparatus 1. The item “Error status” in FIG. 4 indicates that errors occurred from around 8 o'clock to 10 o'clock and from around 13 o'clock to 14 o'clock.

The operation state information included in the operation information In1 is not limited to the example illustrated in FIG. 4. For example, the operation state information may include other information, such as information indicating an idling state period, such as a print image preparation period or a head temperature adjusting period.

Under the item “Error status”, items “Wipe cleaning” and “Strong cleaning” are displayed as cleaning history information.

The item “Wipe cleaning” indicates the time (hour) during which wipe cleaning was performed. Fig. 4 indicates that wipe cleaning was performed at around 11 o'clock, 14 o'clock, and 17 o'clock.

The item “Strong cleaning” indicates the time (hour) during which strong cleaning was performed. The strong cleaning is performed for individual nozzles detected as having ejection failure or the like. Therefore, the items of strong cleaning are provided for the respective colors of Y, M, C, and K, FIG. 4 indicates that strong cleaning has not been performed on this day.

The type of cleaning in the cleaning history information included in the operation information In1 is not limited to the example illustrated in FIG. 4. For example, information on execution of other cleaning, such as normal cleaning, may be included in the operation information. Normal cleaning refers to regularly-performed cleaning each time the image forming apparatus 1 is turned on.

Furthermore, under the item “Strong cleaning”, an item “Non-operational status” is displayed. The item “Non-operational status” indicates the time during which the image forming apparatus I was not operated. Examples of the non-operational state of the image forming apparatus 1 include a setup time, a standby time, and a power-off time. FIG. 4 indicates that the time of the non-operational state of the image forming apparatus 1 is 15.2 hours.

### Operation Information Generating Process

Next, an operation information generating process by the operation information generating apparatus 2 according to the example 1 is described. FIG. 5 is a flowchart illustrating an example of the operation information generating process by the operation information generating apparatus 2 according to the example 1.

First, the operation log obtainer 21 (see FIG. 2) of the operation information generating apparatus 2 obtains an operation log(s) from the image forming apparatus 1 (step S1). In the following description, the word “step” in “step S” may be omitted. Next, the operation information generator 22 generates operation information, based on the operation log obtained in step S1 (S2). The operation information includes operation state information of the image forming apparatus 1 and maintenance history information on maintenance performed on the image forming apparatus 1, which are displayed on the same timeline.

Next, the operation information outputter 23 outputs the operation information to the terminal apparatus 3 (S3). Outputting the operation information to the terminal apparatus 3 is performed by the operation information outputter 23 that uploads the operation information to the dashboard. After step S3, the operation information generating process according to the example 1 ends.

According to the example 1, the operation state information, such as the printing time of the image forming apparatus 1, and the maintenance history information on maintenance performed on the image forming apparatus 1 are displayed on the same timeline. The user can appropriately determine timing (period) to perform next maintenance, based on the operation state of the image forming apparatus 1, the past maintenance execution state, and so forth. For example, the example illustrated in FIG. 4 indicates that wipe cleaning has been performed every three hours. The user can therefore determine to perform next wipe cleaning at about 20 o'clock.

### Example 2

Next, an Example 2 of an embodiment of the present invention will be described. In the Example 2, the operation information generating apparatus 2 displays, on the screen of the terminal apparatus 3, (i) a timeline indicating operation information and (ii) cumulative ejection amounts (an example of cumulative usage amounts) of the respective colors of ink (an example of an image forming medium) of the image forming apparatus 1 at each time (hour) on the timeline.

### Display Example of Operation Information

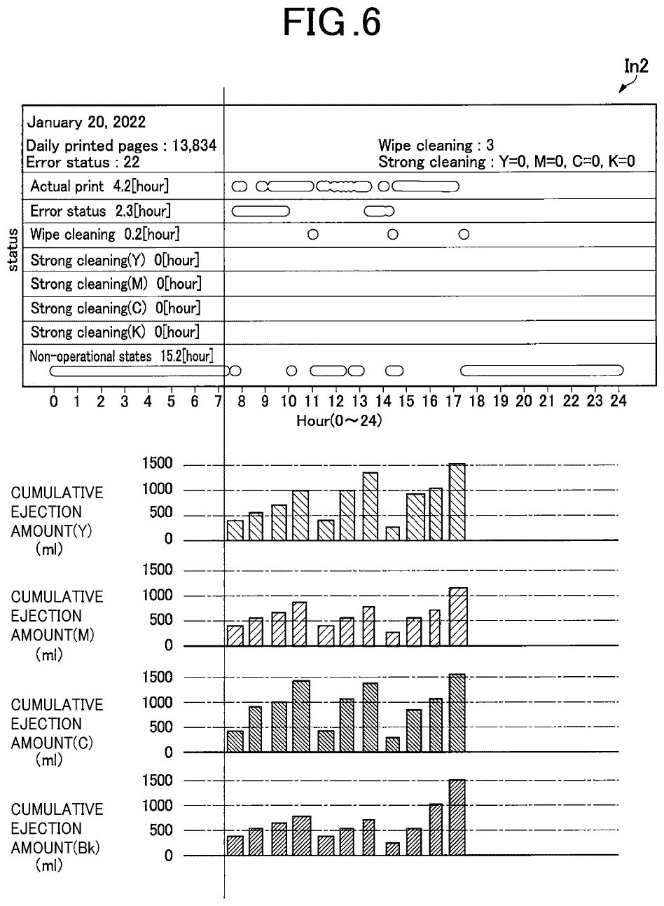

FIG. 6 is a diagram illustrating an example of the operation information In2 displayed on the screen of the display part 53 (see FIG. 2) of the terminal apparatus 3. The operation information In2 includes a timeline indicating operation information and column graphs. The column graphs represent the cumulative ejection amounts (an example of the cumulative printing amounts) of the respective colors of ink by the image forming apparatus 1 at each time of the timeline. The horizontal axis of each column graph indicates time in the timeline, and the vertical axis indicates the cumulative ejection amount (ml) of ink. The graphs indicating the cumulative ejection amounts of the respective colors of ink by the image forming apparatus 1 are not limited to the column graphs and may be other graphs, such as line graphs.

The timeline illustrated in the upper part of FIG. 6 is identical to the timeline of the operation information In1 illustrated in FIG. 4, and description thereof is omitted.

The operation information generator 22 (see FIG. 2) of the operation information generating apparatus 2 calculates the cumulative ejection amounts of the respective colors of ink at each time point in the timeline. Thereafter, the operation information generator 22 resets the calculated cumulative ejection amounts when execution of wipe cleaning or strong cleaning is detected. Wipe cleaning is performed for all the colors of Y, M, C, and K at the same time. Therefore, when execution of wipe cleaning is detected, the operation information generator 22 resets the cumulative ejection amounts of all the colors of ink. On the other hand, strong cleaning is performed for nozzles of a color having ink ejection failure. Therefore, the timing of strong cleaning differs depending on the color. Therefore, when execution of strong cleaning is detected, the operation information generator 22 resets the cumulative ejection amount of the color of ink on which strong cleaning has been performed.

Commonly, the interval of wipe cleaning is determined in association with cumulative ejection amounts of ink, the cumulative number of printed sheets, and so forth. In the present example, the interval of wipe cleaning is associated with the cumulative ejection amounts of ink. For the cumulative ejection amounts of ink, which are associated with the interval of wipe cleaning, an optimal value is determined beforehand, based on experiments or the like. For example, assume that the cumulative ejection amount of ink associated with the interval of wipe cleaning is 1200 ml. In the case, the user checks the timeline and graphs shown in FIG. 6 and determines that the next wipe cleaning is to be performed at the timing the cumulative ejection amount of ink reaches around 1200 ml.

### Operation Information Generating Process

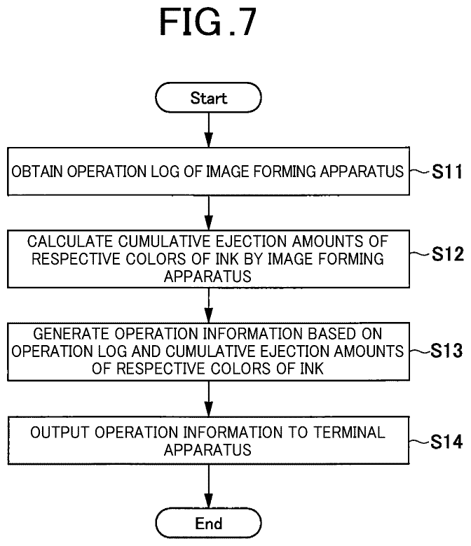

Next, an operation information generating process by the operation information generating apparatus 2 according to the example 2 is described. FIG. 7 is a flowchart illustrating an example of the operation information generating process by the operation information generating apparatus 2 according to the example 2.

First, the operation log obtainer 21 of the operation information generating apparatus 2 obtains an operation log(s) from the image forming apparatus 1 (S11). Next, the operation information generator 22 calculates the cumulative ejection amounts of the respective colors of ink by the image forming apparatus 1 (S12). Next, the operation information generator 22 generates operation information, based on the operation log obtained in step S11 and the cumulative ejection amounts of the respective colors of ink calculated in step S12 (S13).

The operation information generated by the operation information generator 22 in step S13 is, for example, the operation information In2 illustrated in FIG. 6. The operation information In2 includes (i) the timeline indicating the operation state information of the image forming apparatus 1 and the cleaning history information and (ii) column graphs indicating the cumulative ejection amounts of the respective colors of ink at each time point on the timeline. Next, the operation information outputter 23 outputs the operation information to the terminal apparatus 3 (S14). After step S14, the operation information generating process according to the example 2 ends.

According to the example 2, the user checks the cleaning history information indicated in the operation information In2 and the information on the cumulative ejection amounts of the respective colors of ink by the image forming apparatus 1. Thus, the user can determine the optimum timing to perform the next cleaning.

### Example 3

Next, an Example 3 of an embodiment of the present invention is described. In the Example 3, the operation information generating apparatus 2 displays, on the screen of the terminal apparatus 3, a timeline indicating the operation information and the cumulative number of printed sheets by the image forming apparatus 1 at each time point of the timeline.

### Display Example of Operation Information

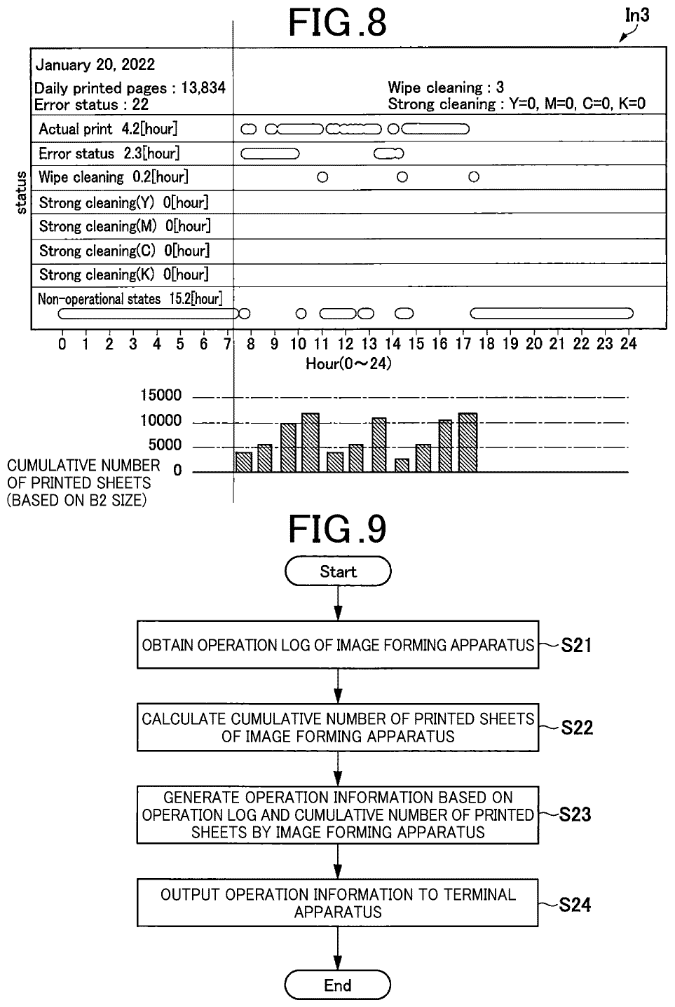

FIG. 8 is a diagram illustrating an example of the operation information In3 displayed on the screen of the display part 53 (see FIG. 2) of the terminal apparatus 3. The operation information In3 includes, below the timeline indicating the operation information, a column graph of the cumulative number of printed sheets by the image forming apparatus 1 at each time point (hour) of the timeline. The horizontal axis of the column graph indicates time of the timeline, and the vertical axis indicates the cumulative number of printed sheets (sheets) by the image forming apparatus 1. The cumulative number of printed sheets by the image forming apparatus 1 illustrated in FIG. 8 is based on the B2 sheet size. Since the timeline illustrated in the upper part of FIG. 8 is identical to the timeline of the operation information In1 illustrated in FIG. 4, description thereof is omitted.

The operation information generator 22 (see FIG. 2) of the operation information generating apparatus 2 calculates the cumulative number of printed sheets by the image forming apparatus 1 at each time of the timeline. Thereafter, the operation information generator 22 resets the calculated cumulative number of printed sheets when execution of wipe cleaning or strong cleaning is detected.

For the cumulative number of printed sheets associated with the interval of wipe cleaning, an optimum value is determined beforehand, based on experiments or the like. Assume that the cumulative number of printed sheets associated with the interval of wipe cleaning is 10,000 sheets, for example, In this case, the user checks the timeline and graph shown in FIG. 8 and determines that the next wipe cleaning is to be performed at the timing the cumulative number of printed sheets reaches around 10,000.

### Operation Information Generating Process

Next, the operation information generating process by the operation information generating apparatus 2 according to the example 3 is described. FIG. 9 is a flowchart illustrating an example of the operation information generating process by the operation information generating apparatus 2 according to the example 3.

First, the operation log obtainer 21 of the operation information generating apparatus 2 obtains an operation log(s) from the image forming apparatus 1 (S21). Next, the operation information generator 22 calculates the cumulative number of printed sheets for the respective colors of ink by the image forming apparatus 1 (S22). Next, the operation information generator 22 generates operation information, based on the operation log obtained in step S21 and the cumulative number of printed sheets calculated in step S22 (S23).

The operation information generated by the operation information generator 22 in step 23 is, for example, the operation information In3 illustrated in FIG. 8. The operation information In3 includes (i) a timeline indicating operation state information of the image forming apparatus 1 and cleaning history information and (ii) the column graph indicating the cumulative number of printed sheets by the image forming apparatus 1 at each time point of the timeline. Next, the operation information outputter 23 outputs the operation information to the terminal apparatus 3 (S24). After step S24, the operation information generating process according to the example 3 ends.

According to the example 3, the user can determine the optimal timing of the next cleaning, based on the cleaning history information and the information on the cumulative number of printed sheets by the image forming apparatus 1, which are indicated in the operation information In3.

### Example 4

Next, an Example 4 of an embodiment of the present invention is described. In the Example 4, the operation information generating apparatus 2 highlights the timing at which maintenance was not performed on the timeline of the operation information.

### Display Example of Operation Information

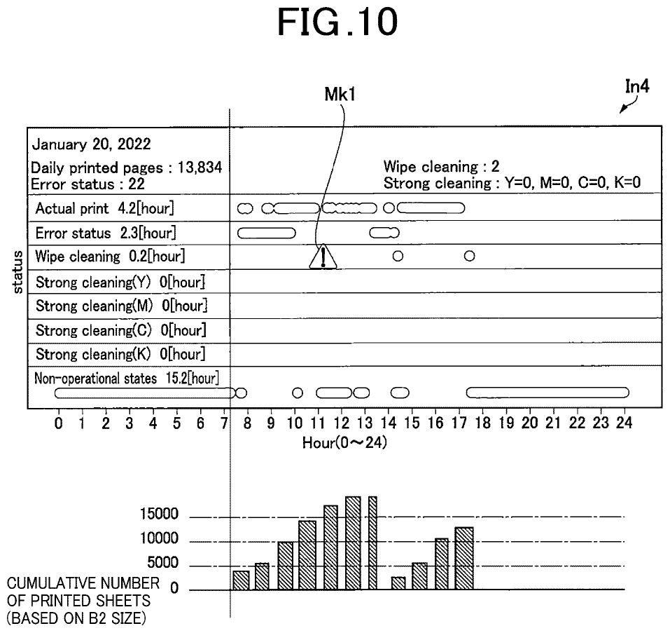

FIG. 10 is a diagram illustrating an example of the operation information In+displayed on the screen of the display part 53 (see FIG. 2) of the terminal apparatus 3. Similarly to the operation information In3 of the Example 3, the operation information In4 includes a column graph of the cumulative number of printed sheets by the image forming apparatus 1 at each time point of the timeline under the timeline of the operation information. The operation information In4 further includes a mark Mk1 indicating a timing at which maintenance was not performed on the timeline. The mark Mk1 is an exclamation mark enclosed by a triangle. The mark Mk1 is shown at a position corresponding to around 11 o'clock on the timeline of the execution timing of wipe cleaning.

The column graph in the operation information In4 indicates the cumulative number of printed sheets by the image forming apparatus 1 from around 10 o'clock to around 13:30. The column graph indicates that the cumulative number of printed sheets associated with the execution timing of the maintenance exceeds 10,000, for example

The user checks the operation information In+illustrated in FIG. 10 and recognizes that wipe cleaning expected at around 11 o'clock was not performed. Accordingly, the user can take measures such as checking the quality of print products printed between 11:00 and around 14:00 at which the next wipe cleaning was performed. Further, by checking the operation information In4 in FIG. 10, the user can determine an optimum timing of the next cleaning, as in the example 3.

FIG. 10 illustrates an example of the operation information In3 according to the example 3, wherein the mark Mk1 is shown on the operation information In3 including the column graph indicating the cumulative number of printed sheets by the image forming apparatus 1. However, the present invention is not limited to the display form of the operation information In3 of the Example 3. The mark Mk1, which indicates the timing at which maintenance was not performed, may be shown on the operation information In2 of the Example 2, namely on the operation information including the column graphs of the cumulative ejection amounts of the respective colors of ink by the image forming apparatus 1.

### Operation Information Generating Process

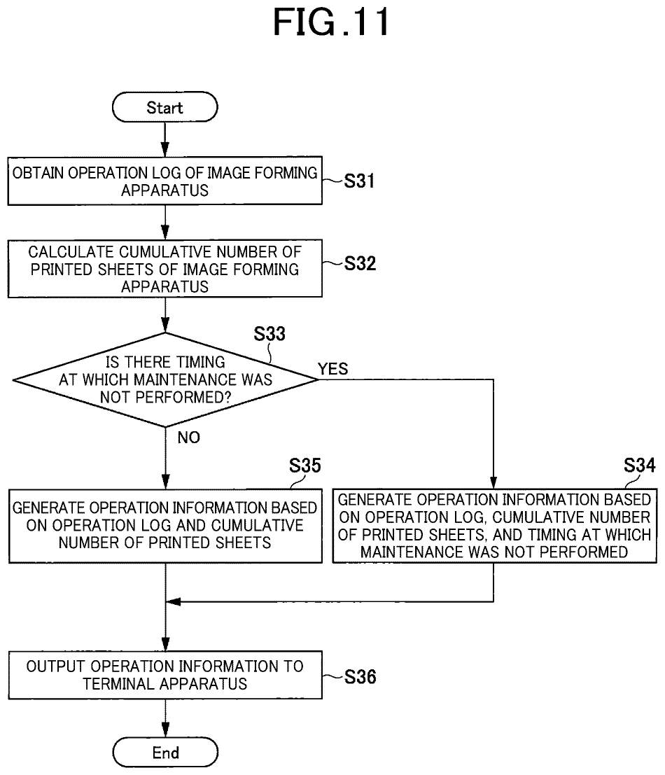

Next, the operation information generating process by the operation information generating apparatus 2 according to an example 4 is described. FIG. 11 is a flowchart illustrating an example of the operation information generating process by the operation information generating apparatus 2 according to the example 4.

First, the operation log obtainer 21 of the operation information generating apparatus 2 obtains an operation log(s) from the image forming apparatus 1 (S31). Next, the operation information generator 22 calculates the cumulative number of printed sheets for the respective colors of ink by the image forming apparatus 1 (S32). Next, based on the operation log obtained in step S31, the operation information generator 22 determines whether there is a timing the maintenance was not performed (S33). When determining that there is a timing maintenance was not performed (S33: YES), the operation information generator 22 generates operation information, based on the following information. For example, the operation information generator 22 generates the operation information, based on the operation log obtained in S31, the cumulative number of printed sheets calculated in S32, and the timing at which maintenance was not performed (S34).

The operation information generated by the operation information generator 22 in step 34 is, for example, the operation information In4 illustrated in FIG. 10. The operation information In4 includes the timeline on which the mark Mk1 highlights the timing at which maintenance should have been performed and the column graph indicating the cumulative number of printed sheets at each time point of the timeline.

On the other hand, when determining that there is no timing at which the maintenance was not performed (S33: NO), the operation information generator 22 generates the operation information based on the following information. For example, the operation information generator 22 generates the operation information, based on the operation log obtained in S31 and the cumulative number of printed sheets calculated in S32 (S35). After step S34 or step 35, the operation information outputter 23 outputs the operation information to the terminal apparatus 3 (S36). After step S36, the operation information generating process according to the example 4 ends.

According to the Example 4, the user can determine an optimum timing of the next cleaning. In the determination, the user refers to the cleaning history information, the cumulative number of printed sheets by the image forming apparatus 1, and the mark Mk1, which are indicated in the operation information In4. Further, according to the example 4, the user can take measures such as checking the quality of print products printed in a specific period, based on the position of the mark Mk1. The specific period is between the timing at which maintenance was not appropriately performed and the timing at which the next maintenance was performed.

### Example 5

Next, an Example 5 of an embodiment of the present invention is described. In the Example 5, the operation information generating apparatus 2 highlights the optimum execution timing of the next maintenance on the timeline included in the operation information.

### Display Example of Operation Information

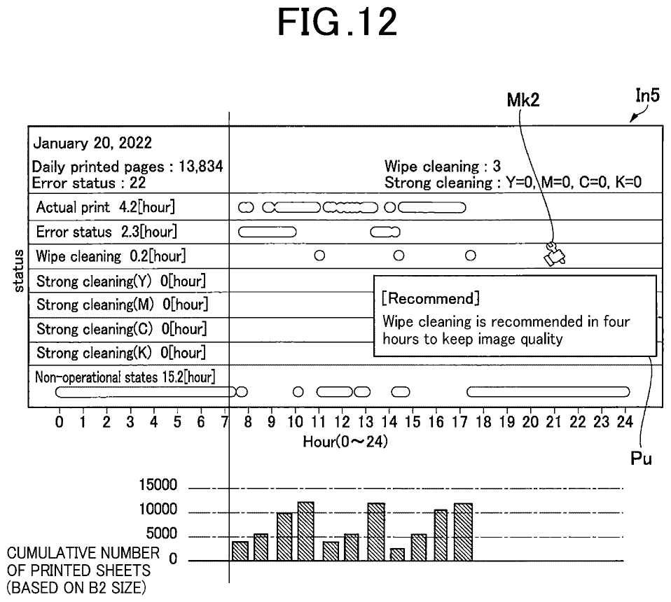

FIG. 12 is a diagram illustrating an example of the operation information In5 displayed on the screen of the display part 53 (see FIG. 2) of the terminal apparatus 3. Similarly to the operation information In3 of the Example 3, the operation information In5 includes the column graph of the cumulative number of printed sheets by the image forming apparatus 1 at each time point of the timeline under the timeline of the operation information. The operation information In5 further includes a mark Mk2 indicating an optimum timing of the next maintenance on the timeline. The mark Mk2 is a mark of a hand holding a tool and is arranged at a position corresponding to around 21 o'clock on the timeline indicating the execution timing of wipe cleaning.

In the operation information In5 illustrated in FIG. 12, a pop-up screen Pu for notifying the recommended timing of the next cleaning is displayed near the mark Mk2. The pop-up screen Pu includes a message saying “[Recommend] Wipe cleaning is recommended in four hours to keep image quality”.

By checking the operation information In5 illustrated in FIG. 12, the user can recognize that wipe cleaning need be performed to keep image quality. Further, the user can recognize that the recommended timing of wipe cleaning is 21:00, which is four hours later from now.

### Operation Information Generating Process

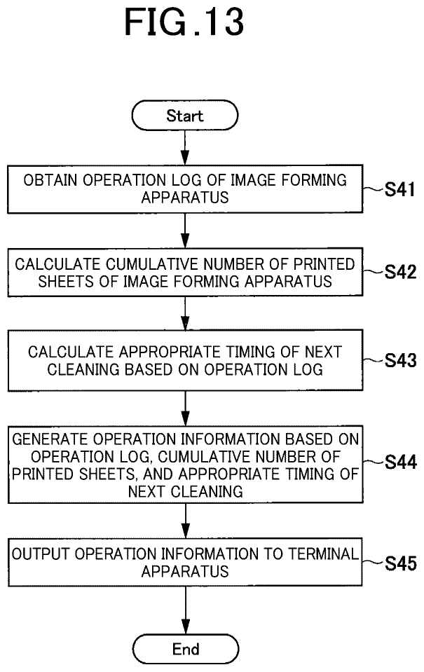

Next, the operation information generating process by the operation information generating apparatus 2 according to the example 5 is described. FIG. 13 is a flowchart illustrating an example of the operation information generating process by the operation information generating apparatus 2 according to the example 5.

First, the operation log obtainer 21 of the operation information generating apparatus 2 obtains an operation log(s) from the image forming apparatus 1 (S41). Next, the operation information generator 22 calculates the cumulative number of printed sheets by the image forming apparatus 1 (S42). Next, the operation information generator 22 calculates an appropriate timing of the next maintenance, based on the operation log obtained in step S41 (S43).

Next, the operation information generator 22 generates operation information. The operation information generator 22 generates the operation information, based on the operation log obtained in S41, the cumulative number of printed sheets calculated in S42, and the appropriate timing of the next maintenance calculated in S43 (S44).

The operation information generated by the operation information generator 22 in step 44 is, for example, the operation information In5 illustrated in FIG. 12. The operation information In5 includes the timeline in which the mark Mk2 highlights an appropriate timing of the next maintenance and the column graph indicating the cumulative number of printed sheets at each time point of the timeline.

After step 44, the operation information outputter 23 outputs the operation information to the terminal apparatus 3 (S45). After step S45, the operation information generating process according to the example 5 ends.

According to the example 5, the user can recognize the optimum timing of the next cleaning, based on the cleaning history information indicated in the operation information In5, the cumulative number of printed sheets by the image forming apparatus 1, and the mark Mk2.

The present invention is not limited to the above-described embodiments, and various other application examples and modification examples can be adopted without departing from the spirit and scope of the present invention described in the claims.

In the above-described embodiment, the image forming apparatus, from which the operation information generating apparatus 2 of the present invention obtains the operation log, is an inkjet image forming apparatus. However, the present invention is not limited to this. The present invention may be applied to an image forming apparatus employing a different image forming method, as long as the image forming apparatus is subjected to maintenance at a predetermined cycle for maintaining the quality of images formed on sheets.

What is claimed is:

1. An operation information generating apparatus comprising a hardware processor configured to
obtain operation state history information on an operation state of an image forming apparatus and maintenance history information on maintenance performed on an image former of the image forming apparatus,
generate operation information in which the operation state history information and the maintenance history information are shown on a timeline, and
output the generated operation information to a terminal apparatus.

2. The operation information generating apparatus according to claim 1, wherein the maintenance included in the operation information is performed at a predetermined cycle.

3. The operation information generating apparatus according to claim 2, wherein the operation state of the image forming apparatus includes a state in which the image forming apparatus is forming an image.

4. The operation information generating apparatus according to claim 3, wherein the operation information includes information on a cumulative usage amount of an image forming medium used for image formation by the image former at a predetermined time point on the timeline.

5. The operation information generating apparatus according to claim 3, wherein the operation information includes information on a cumulative number of sheets printed by the image former at a predetermined time point on the timeline.

6. The operation information generating apparatus according to claim 4, wherein the operation information includes information on a mark indicating a timing in a past at which the maintenance should have been performed.

7. The operation information generating apparatus according to claim 4, wherein the operation information includes information on a mark indicating a recommended timing of the next maintenance.

8. An operation information generating method comprising:
obtaining operation state history information on an operation state of an image forming apparatus and maintenance history information on maintenance performed on an image former of the image forming apparatus;
generating operation information in which the operation state history information and the maintenance history information are arranged on a timeline; and
outputting the generated operation information to a terminal apparatus.
